(19) United States
(12) Patent Application Publication
(10) Pub. No.: US 2026/0252347 A1
(43) Pub. Date: Aug. 27, 2026

(54) EVALUATION OF CODE SUMMARIES GENERATED BY LARGE LANGUAGE MODELS (LLM)

(71) Applicant: Oracle International Corporation, Redwood Shores, CA (US)

(72) Inventors: Irfan Mekic, Angier, NC (US); Geoffrey Stewart, Belmont, CA (US)

(73) Assignee: Oracle International Corporation, Redwood Shores, CA (US)

(21) Appl. No.: 19/065,458

(22) Filed: Feb. 27, 2025

(51) Int. Cl. G06F 8/73

(52) U.S. Cl. CPC G06F 8/73

(57) ABSTRACT

Disclosed are techniques for evaluating code summaries generated from code blocks and by machine learning (ML) models, such as large language models (LLMs). A first ML model generates a code summary that summarizes an original code block. A second ML model generates, based at least in part on the code summary, a reconstructed code block. A first embedding vector is generated, based at least in part on the original code block. A second embedding vector is generated, based at least in part on the reconstructed code block. The first embedding vector and the second embedding vector are correlated. Based at least in part on the correlation between the first embedding vector and the second embedding vector, a quality score is assigned to the code summary.

### BACKGROUND

In the burgeoning field of artificial intelligence (AI), utilization of machine learning (ML) models has become a cornerstone for developing numerous AI applications. For example, large language models (LLMs) are a type of ML model trained on text data, allowing it to understand and generate human language and perform tasks like text generation, translation, question answering, and summarization. Among other things, an LLM may analyze a block of computer code, and generate a natural language description that captures the essential logic and purpose of the code, effectively summarizing what the code does. Thus, the LLM is provided with the block of code and a prompt to summarize the block of code, and the LLM outputs a natural language summary of the block of code.

### BRIEF SUMMARY

In various embodiments, a non-transitory computer-readable medium includes instructions that when executed by one or more processors, cause a system including the one or more processors to perform operations including: generating, by a first machine learning (ML) model, a code summary that summarizes an original code block; generating, by a second ML model and based at least in part on the code summary, a reconstructed code block; generating a first embedding vector, based at least in part on the original code block; generating a second embedding vector, based at least in part on the reconstructed code block; correlating the first embedding vector and the second embedding vector; and based at least in part on correlating the first embedding vector and the second embedding vector, assigning a quality score to the code summary.

In an example, correlating the first embedding vector and the second embedding vector comprises: correlating the first embedding vector and the second embedding vector by (i) determining a cosine similarity between the first embedding vector and the second embedding vector, and (ii) generating a cosine similarity metric, based at least in part on the cosine similarity between the first embedding vector and the second embedding vector. In an example, assigning the quality score to the code summary comprises: assigning the quality score to the code summary, based at least in part on the cosine similarity metric. In an example, assigning the quality score to the code summary comprises: assigning the cosine similarity metric as the quality score to the code summary. In an example, the code summary is a first code summary, the reconstructed code block is a first reconstructed code block, the quality score is a first quality score, and wherein the operations further include: generating, by the first ML model, a second code summary that summarizes the original code block; generating, by the second ML model and based at least in part on the second code summary, a second reconstructed code block; generating a third embedding vector, based at least in part on the second reconstructed code block; correlating the first embedding vector and the third embedding vector; and based at least in part on correlating the first embedding vector and the third embedding vector, assigning a second quality score to the second code summary. In an example, the operations further include: determining that the first quality score is higher than the second quality score; and based at least in part on determining that the first quality score is higher than the second quality score, selecting the first code summary over the second code summary as a relatively better summary of the original code block. In an example, generating, by the first ML model, the first code summary comprises generating the first code summary based at least in part on a first prompt provided to the first ML model; generating, by the first ML model, the second code summary comprises generating the second code summary based at least in part on a second prompt provided to the first ML model, wherein the first prompt and the second prompt are different; and the operations further include: refraining from varying a plurality of inference parameters of the first ML model while the first code summary and the second code summary are generated, such that differences between the first code summary and the second code summary are due to differences between the first prompt and the second prompt. In an example, generating, by the first ML model, the first code summary and the second code summary comprises generating the first code summary and the second code summary based at least in part on a same prompt provided to the first ML model; and the operations further include: configuring (i) a first set of values for a plurality of inference parameters of the first ML model while the first code summary is being generated and (ii) a second set of values for the plurality of inference parameters of the first ML model while the second code summary is being generated, such that differences between the first code summary and the second code summary are due to differences between the first set of values and the second set of values.

In an example, the code summary is a first code summary, the reconstructed code block is a first reconstructed code block, the quality score is a first quality score, and wherein the operations further include: generating, by a third ML model, a second code summary that summarizes the original code block; generating, by the second ML model and based at least in part on the second code summary, a second reconstructed code block; generating a third embedding vector, based at least in part on the second reconstructed code block; correlating the first embedding vector and the third embedding vector; and based at least in part on correlating the first embedding vector and the third embedding vector, assigning a second quality score to the second code summary. In an example, the operations further include: evaluating a suitability of the first ML model versus the third ML model for generating code summaries, based at least in part on the first quality score and the second quality score. In an example, the second ML model is a fixed ML model, such that a plurality of inference parameters of the second ML model is fixed during generation of the first reconstructed code block and during generation of the second reconstructed code block. In an example, the first ML model is a first large language model (LLM) and the second ML model is a second LLM. In an example, the quality score is indicative of a quality of the code summary generated by the first ML model.

In various embodiments, a computer implemented method comprises: generating, by a first machine learning (ML) model, a code summary that summarizes an original code block; generating, by a second ML model and based at least in part on the code summary, a reconstructed code block; correlating the original code block and the reconstructed code block; and based at least in part on correlating the original code block and the reconstructed code block, assigning a quality score to the code summary. In an example, correlating the original code block and the reconstructed code block comprises: generating a first embedding vector, based at least in part on the original code block; generating a second embedding vector, based at least in part on the reconstructed code block; and correlating the first embedding vector and the second embedding vector. In an example, correlating the first embedding vector and the second embedding vector comprises: determining a cosine similarity between the first embedding vector and the second embedding vector; and generating a cosine similarity metric, based at least in part on the cosine similarity between the first embedding vector and the second embedding vector, wherein the quality score is assigned to the code summary, based at least in part on the cosine similarity metric. In an example, the first ML model is a first large language model (LLM) and the second ML model is a second LLM.

In various embodiments, a system comprises: one or more processors; and one or more non-transitory computer-readable media storing instructions, which, when executed by the system, cause the system to perform a set of actions including: generating, by a first machine learning (ML) model, a code summary that summarizes an original code block; generating, by a second ML model and based at least in part on the code summary, a reconstructed code block; correlating the original code block and the reconstructed code block; and based at least in part on correlating the original code block and the reconstructed code block, assigning a quality score to the code summary. In an example, correlating the original code block and the reconstructed code block comprises: generating a first embedding vector, based at least in part on the original code block; generating a second embedding vector, based at least in part on the reconstructed code block; and correlating the first embedding vector and the second embedding vector. In an example, the first ML model is a first large language model (LLM) and the second ML model is a second LLM.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a system for scoring a plurality of natural language code summaries generated from a code block and by a code summarization large language model (LLM).

FIG. 2 illustrates a system for scoring a plurality of natural language code summaries generated from a code block and by a code summarization LLM, where a corresponding plurality of prompts are used to generate the plurality of natural language code summaries.

FIG. 3 illustrates a system for scoring a plurality of natural language code summaries that are generated by a plurality of code summarization LLMs and from a code block.

FIG. 4 illustrates a code summary evaluation service that may be usable with any of the systems of FIGS. 1-3.

FIG. 5 illustrates the code summary evaluation service of FIG. 4, wherein the code summary evaluation service in FIG. 5 generates two different code summary quality scores for two different code summaries generated by a code summarization LLM.

FIG. 6 illustrates a code correlation service.

FIG. 7 illustrates operation of a code summary evaluation service that generates respectively two different code summary quality scores for two different code summaries generated by a code summarization LLM.

FIG. 8 illustrates a flow chart depicting a method for evaluation of a code summary generated by a code summarization LLM.

FIG. 9 depicts a simplified diagram of a distributed system for implementing certain aspects.

FIG. 10 is a simplified block diagram of one or more components of a system environment by which services provided by one or more components of an embodiment system may be offered as cloud services, in accordance with certain aspects.

FIG. 11 illustrates an example computer system that may be used to implement certain aspects.

### DETAILED DESCRIPTION

As described above, an LLM may analyze a block of computer code, and generate a natural language description that captures the essential logic and purpose of the code, effectively summarizing what the code does. Thus, the LLM is provided with the block of code and a prompt to summarize the block of code, and the LLM outputs a natural language summary of the block of code.

In an example, to evaluate a code summarization ability of such an LLM, a curated and labeled evaluation datasets of the following form may be used:
<code block>:<natural language summary of code>

During the evaluation process, the LLM that is being evaluated is fed the code block from the evaluation dataset, and is prompted to summarize the code block. The LLM outputs the code summary, which is then compared to the “ground truth” natural language summary of code in the evaluation dataset. The comparison (which may be performed via semantic embeddings, for example) provides an assessment of a quality of the code summary generated by the LLM, and consequently, evaluates a code summarization ability of the LLM. However, such an approach is not feasible in settings where an evaluation dataset does not exist, such as when the LLM is in a live, production environment.

Accordingly, disclosed herein are techniques for evaluating code summaries generated from code blocks and by machine learning (ML) models, such as large language models (LLMs). No labeled evaluation dataset (e.g., having a ground truth summary of the code blocks) are used during such an evaluation process. The techniques can be applied to LLMS in live, production environment. The techniques may be used to access code summarization quality of an LLM in real or near-real time settings. The techniques allow for the continual evaluation of code summary abilities of one or more LLMs in an automated fashion, ensuring that any degradation in code summarization ability of an LLM is captured in real or near-real time. In an example, the techniques may be used to generate (e.g., by a single LLM or by more than one LLM) multiple code summaries corresponding to a single code block, and for a suitable (such as a most suitable) one of the code summaries to be selected and used for downstream tasks.

LLM(s) generating code summaries are also referred to herein as code summarization LLMs, although such LLMs may be general purpose LLMs that can, among other things, also generate natural language summaries of code blocks (or may be special purpose LLMs focused on processing codes and generating corresponding code summaries).

In an example, a code summarization LLM generates a code summary, e.g., by summarizing an original code block. Subsequently, another LLM (referred to herein as a code generation LLM, for ease of identification) generates, based at least in part on the code summary, a reconstructed code block. For example, the code generation LLM does not have access to the original code block. Rather, the code generation LLM generates the reconstructed code block, based on the code summary.

If the code summarization LLM accurately summarized the original code block, ideally the original code block and the reconstructed code block should have high correlation. Accordingly, to evaluate the ability of the code summarization LLM in generating the code summary and/or to evaluate the code summary generated by the code summarization LLM, the original code block and the reconstructed code block are correlated, and a degree of correlation provides a code summary quality score.

In an example, to correlate the original code block and the reconstructed code block, a code embedding service receives the original code block and the reconstructed code block. Code embedding performed by the code embedding service converts a code block into a numerical representation, also referred to as an embedding vector. The code embedding service performs a code embedding of the reconstructed code block, to generate a reconstructed embedding vector. Similarly, the code embedding service performs a code embedding of the original code block, to generate an original embedding vector.

The original embedding vector captures the semantics, structure, and/or functionality of the original code block. Similarly, the reconstructed embedding vector captures the semantics, structure, and/or functionality of the reconstructed code block.

The original embedding vector and the reconstructed embedding vector are then normalized, and correlated. The correlation of the original embedding vector and the reconstructed embedding vector may be performed, for example, by determining a cosine similarity metric between the two embedding vectors. The cosine similarity metric is an indication of a closeness of the original embedding vector and the reconstructed embedding vector in the vector space. In an example, cosine similarity metric is bounded between −1 and 1. For example, the cosine similarity metric being closer to 1 implies that the two embedding vectors are closer to one another, and the cosine similarity metric being closer to 0 implies that the two embedding vectors are further from one another. Accordingly, in an example, the cosine similarity metric being closer to 1 implies that the reconstructed code block and the original code block are relatively more similar (such as semantically, structurally, and/or functionality similar) to one another, and the cosine similarity metric being closer to 0 implies that the reconstructed code block and the original code block are relatively dissimilar (such as semantically, structurally, and/or functionality dissimilar) from one another.

In an example, a code summary quality score is generated for the code summary, based on the cosine similarity metric. For example, based on the cosine similarity metric, a judgement may be taken on a quality of the code summary generated by the code summarization LLM. In an example, the cosine similarity metric may be output as the code summary quality score. In another example, a trained ML model may be used to generate the code summary quality score, based on the cosine similarity metric.

Although the above discussion pertains to evaluation of a single code summary quality score corresponding to a single code summary, the techniques may be applied to generate a plurality of code summary quality scores corresponding to a plurality of code summaries. Various use cases, configurations, variations, and examples are described in detail herein below.

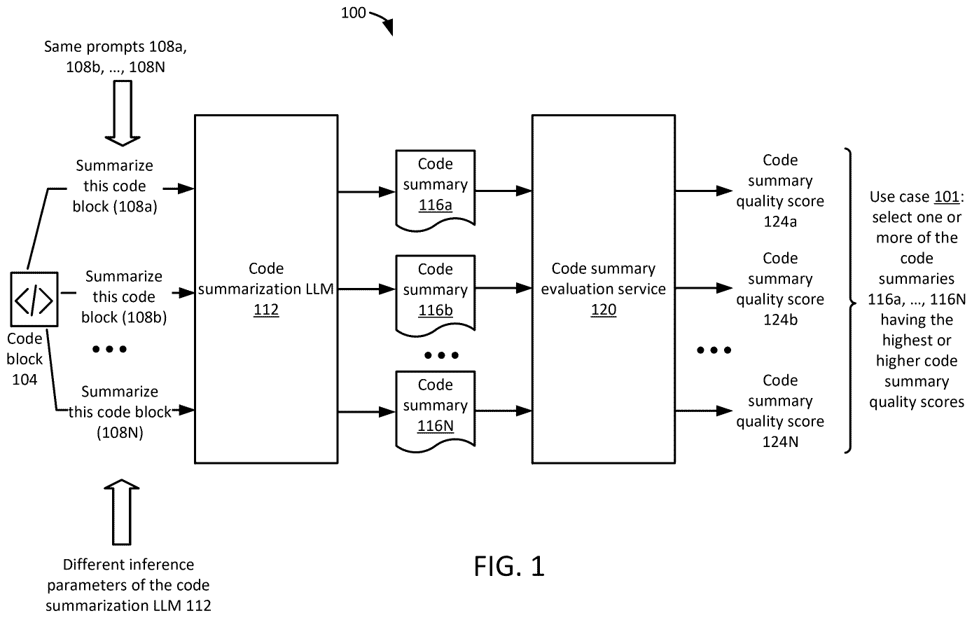

FIG. 1 illustrates a system 100 for scoring natural language code summaries 116a, . . . , 116N generated from a code block 104 and by a code summarization LLM 112.

The system 100 includes the code summarization LLM 112. In an example, the code summarization LLM 112 may be a general purpose LLM that can, among other things, also generate natural language summaries of code blocks. In another example, the code summarization LLM 112 may be a special purpose LLM that specifically is involved in computer coding, such as generating natural language summaries of code blocks. This disclosure is not limited by a particular type of the code summarization LLM 112. The code summarization LLM 112 is identified with the prefix “code summarization” due to its ability to summarize code blocks and generate corresponding natural language summaries, and the LLM 112 may, or may not perform one or more other tasks that an LLM may perform.

The code summarization LLM 112 receives code blocks and generates corresponding natural language summaries of the code blocks. For example, in FIG. 1, the code summarization LLM 112 receives the code block 104.

In an example, prompting an LLM multiple times can result in different outputs. For example, in FIG. 1, the code summarization LLM 112 is prompted N times, such as prompts 108a, 108b, . . . , 108N, where in the example of FIG. 1, each of the prompts 108a, 108b, . . . , 108N is “Summarize this code block,” and where N is a positive integer greater than one.

In response to the prompts 108a, 108b, . . . , 108N, the code summarization LLM 112 respectively outputs code summaries 116a, 116b, . . . , 116N. Each code summary 116 is a natural language summary of the code block 104. In an example, because prompting an LLM multiple times can result in different outputs, the code summaries 116a, 116b, . . . , 116N may be different from each other, as described below in further detail.

In an example, the code block 104 may be a complete block of code for a program, or a section or snippet of a complete block of code. The code block 104 can be for any appropriate program, and may be written in any language that is supported by the code summarization LLM 112. A length of the code block 104 may be based on a maximum length of a code block that can be processed by the code summarization LLM 112. Any technique employed by code summarization LLMs to generate code summaries can be employed to generate the code summaries 116a, . . . , 116N, based on the code block 104 and the prompts 108a, . . . , 108N.

In an example, the code summarization LLM 112 comprises a plurality of inference parameters, which may be randomly or pseudo-randomly selected by the code summarization LLM 112 (or may be configured via an operator of the code summarization LLM 112). The inference parameters control a manner in which the code summarization LLM 112 generates a response (which in the example of FIG. 1 are code summaries).

Examples of such inference parameters include one or more of a temperature, top-k sampling, pop-p sampling (also referred to as nucleus sampling), repetition penalty, beam search, latency and throughput, and/or one or more other inference parameters. For example, a temperature of the code summarization LLM 112 controls randomness in the output of the code summarization LLM 112 (e.g., a higher temperature value results in the output being relatively more creative, and a lower temperature value results in the output being relatively more deterministic). A top-k sampling selects from the top-k most probable words at each step. A top-p sampling selects words dynamically based on a cumulative probability mass. A repetition penalty discourages repetitive outputs. A beam search allows finding an optimal or sub-optimal sequence of words. A latency and throughput aim to specify a time taken per inference and a number of tokens processed per second.

In an example, the inference parameters of the code summarization LLM 112 may be varied (e.g., in a random or pseudo-random manner and by the code summarization LLM 112) between the generation of the code summaries 116a, . . . , 116N. For example, the code summarization LLM 112 may use a first set of values for the inference parameters while generating the code summary 116a, use a second set of values for the inference parameters while generating the code summary 116b, use a N^{th} set of values for the inference parameters while generating the code summary 116N, and so on, where the various sets of values may be different from one another. The variation or differences in the code summaries 116a, . . . , 116N may be due to such differences in the inference parameters while generating the code summaries 116a, . . . , 116N.

In an example, the code block 104 may include calls of one or more external functions. One or more such external functions may not be a part of the code block 104 provided to the code summarization LLM 112. Accordingly, in an example, the code summarization LLM 112 may not attempt to access and crawl through such external function(s). A code summary 116 may not (or may) attempt to understand the value returned from the function. Instead, the code summary 116 may indicate a call being made to an external function, and operations performed on the value returned from the function. Note that the code summary 116 may be in natural language (such as English, or another selectable language), and not in a computer coding language.

In an example, the system 100 further comprises a code summary evaluation service 120 that evaluates the code summaries 116a, . . . , 116N, and outputs code summary quality scores 124a, . . . , 124N, respectively, as illustrated in FIG. 1. For example, the code summary quality score 124a is indicative of a quality of the code summary 116a; the code summary quality score 124N is indicative of a quality of the code summary 116N, and so on.

In an example, a quality of a code summary 116 is indicative of how well the original code block 104 can be reproduced from the code summary 116. In an example, a quality of a code summary 116 is indicative of how well the code summary 116 summarizes the original code block 104, such that the original code block 104 can be reproduced from code summary 116. The code summary quality scores 124a, . . . , 124N and example operation of the code summary evaluation service 120 are described below in further detail.

FIG. 1 also illustrates an example use case 101, in which one or more of the code summaries 116a, . . . , 116N can be selected, based on the code summary quality scores 124a, . . . , 124N. For example, the code summary quality scores 124a, . . . , 124N can be used to evaluate the code summaries 116a, . . . , 116N. One or more of the code summaries 116a, . . . , 116N can be selected based on the code summary quality scores 124a, . . . , 124N. For example, a code summary quality score with the highest score among the code summary quality scores 124a, . . . , 124N is selected, and the corresponding code summary is considered as a suitable (such as a most suitable) code summary of the plurality of code summaries 116a, . . . , 116N. Thus, in this example use case 101, the system 100 is used to select most suitable one or more of the plurality of code summaries 116a, . . . , 116N.

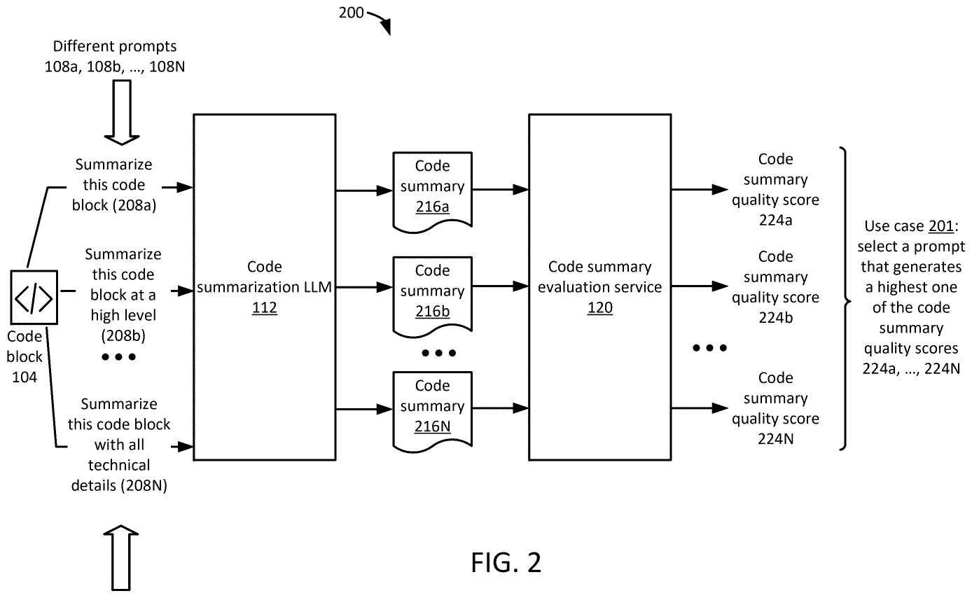

FIG. 2 illustrates another system 200 for scoring a plurality of natural language code summaries 216a, . . . , 216N generated from a code block 104 and by a code summarization LLM 112, where a corresponding plurality of prompts are used to generate the plurality of natural language code summaries 116a, . . . , 116N. The system 200 of FIG. 2 is at least in part similar to the system 100 of FIG. 1. For example, the system 200 of FIG. 2 includes (i) the code summarization LLM 112 receiving the code block 104 along with a plurality of command prompts 208a, . . . , 208N, and respectively generating the plurality of natural language code summaries 216a, . . . , 216N, and (ii) the code summary evaluation service 120 for generating a plurality of code summary quality scores 224a, . . . , 224N corresponding to the plurality of natural language code summaries 216a, . . . , 216N, respectively. Also, unlike FIG. 1 that illustrates a use case 101, FIG. 2 illustrates another use case 201.

In the user case 101 of the system 100 of FIG. 1, a same language “Summarize this code block” is used for all the prompts 108a, 108b, . . . , 108N. In contrast, in the system 200 FIG. 2, different prompts 208a, 208b, . . . , 208N are used to generate code summaries 216a, 216b, . . . , 216N, respectively, for the code block 104. Merely as an example, the prompt 208a specifies “Summarize this code block,” the prompt 208b specifies “Summarize this code block at a high level,” and the prompt 208N specifies “Summarize this code block with all technical details.” Note that these prompts are mere examples, and the actual language of the prompts may vary from one embodiment to the next.

The code summary quality scores 224a, . . . , 224N are compared, to select a highest code summary quality score. In the use case 201 of FIG. 2, a prompt corresponding to the highest code summary quality score is selected as a reasonably good prompt, such as a suitable prompt among the prompts 208a, 208b, . . . , 208N (e.g., select a prompt that generates a highest one of the code summary quality scores 224a, . . . , 224N). Thus, the user case 201 of FIG. 2 is associated with selecting a prompt that generates a highest one of the code summary quality scores 224a, . . . , 224N.

Note that in FIG. 1, one or more inference parameters of the code summarization LLM 112 may be varied between the generation of the code summaries 116a, . . . , 116N, as described above with respect to FIG. 1. In contrast, in FIG. 1, the inference parameters of the code summarization LLM 112 have the same set of values, while generating the code summaries 216a, . . . , 216N. For example, the code summarization LLM 112 may use the set of values for the inference parameters while generating the code summaries 216a, . . . , 216N.

Thus, the variability in FIG. 1 was the different sets of inference parameters and the same prompt. In contrast, to make the comparison between the various prompts 208a, 208b, . . . , 208N fair, same sets of inference parameters may be used for the code summarization LLM 112 while generating the code summaries 216a, . . . , 216N. For example, an operator of the code summarization LLM 112 may configure and/or prompt the code summarization LLM 112 to use the same sets of parameters while generating the code summaries 216a, . . . , 216N.

Note that while a prompt 208 may be well suited for a specific code block 104, it may not be deemed to be a suitable prompt for another code block. Thus, if the task is to select a most suitable (or best) prompt among the prompts 208a, . . . , 208N for generation of code summaries, then an average of the code summary quality scores may be calculated, e.g., by repeating the process depicted in FIG. 2 and for a plurality of different types of code blocks and different prompt languages. The prompt language among the prompts 208a, . . . , 208N, having a highest average, may be selected as a most suitable prompt among the prompts 208a, . . . , 208N, in an example.

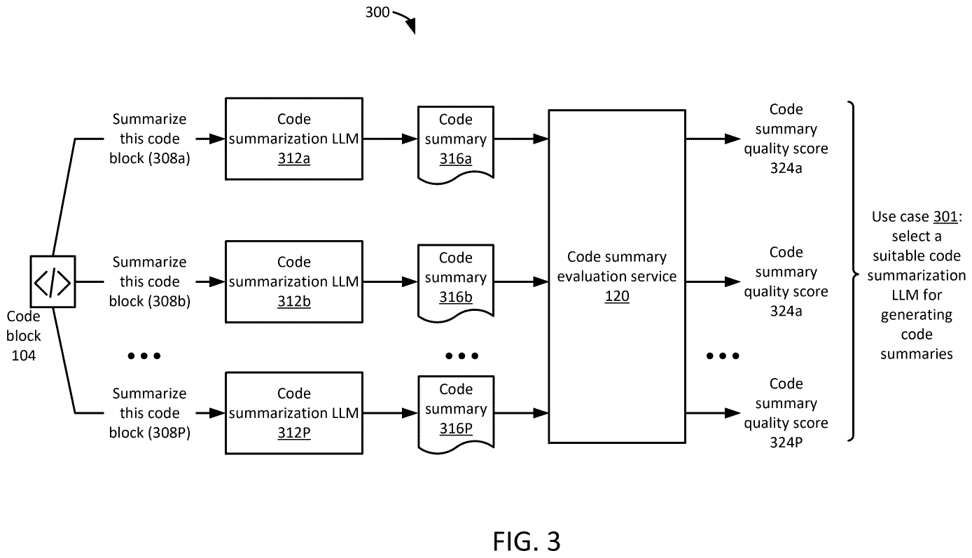

FIG. 3 illustrates a system 300 for scoring a plurality of natural language code summaries 316a, . . . , 316P that are generated by a plurality of code summarization LLMs and from a code block 104. Unlike the system 100 of FIG. 1, the system 300 of FIG. 3 includes a plurality of code summarization LLMs 312a, 312b, . . . , 312P, where P is a positive integer greater than one. Each code summarization LLM 312 processes the code block 104 based on a corresponding prompt 308, and generates a corresponding code summary 316. The code summary evaluation service 120 processes the plurality of code summaries 316a, . . . , 316P, to respectively generate a corresponding plurality of code summary quality scores 324a, . . . , 324P. In a use case 301 depicted in FIG. 3, a code summarization LLM with a corresponding highest code summary quality score (e.g., among the code summary quality scores 324a, . . . , 324P) may be considered suitable (such as most suitable or best) among the code summarization LLMs 312 a, . . . , 312P for generation of code summaries.

Note that while a code summarization LLM may be suited for a specific code block 104, it may not be deemed to be a suitable code summarization LLM for another code block. Thus, if the task is to select a suitable code summarization LLM (e.g., among the code summarization LLMs 312a, . . . , 312P), then an average of the code summary quality scores may be calculated, e.g., by repeating the process depicted in FIG. 3 and for a plurality of different types of code blocks and/or for a plurality of prompts. The code summarization LLM 312 having a highest average may be selected as a suitable (or most suitable or best) code summarization LLM 112 among the code summarization LLMs 312a, 312b, . . . , 324P, in an example.

FIGS. 1, 2, and 3 illustrate different use cases 101, 201, 301, respectively, that utilize code summary quality scores generated by the code summary evaluation service 120. However, other use cases may also be envisioned, e.g., based on the teachings of this disclosure.

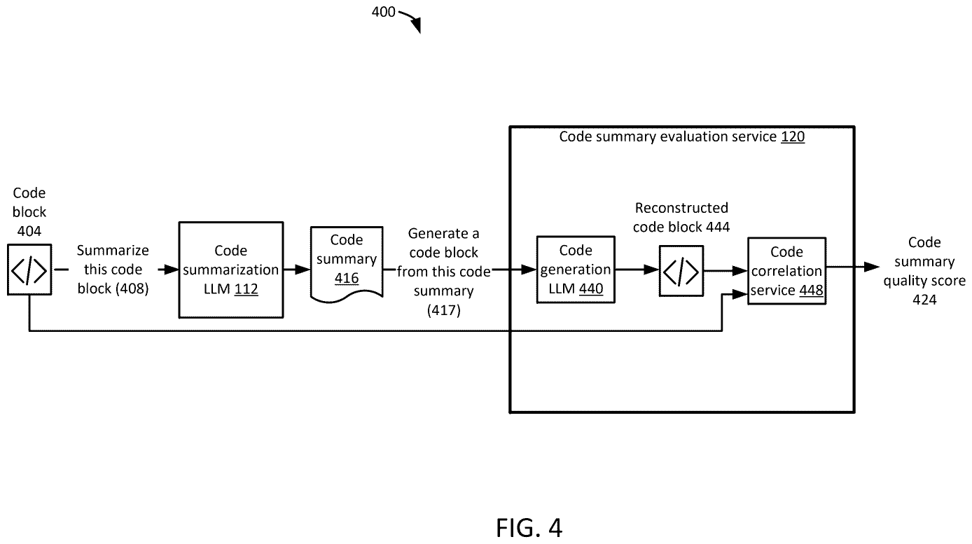

FIG. 4 illustrates a code summary evaluation service 120 that may be usable with any of the systems 100, 200, or 300 of FIGS. 1-3. For example, in the system 400 of FIG. 4, the code summarization LLM 112 receives a code block 404, along with a prompt 408 to summarize the code block 404. The code summarization LLM 112 generates a code summary 416 in response. The code summary evaluation service 120 evaluates the code summary 416, to generate a code summary quality score 424.

Note that FIG. 4 illustrates the code summary evaluation service 120 generating a single code summary quality score 424 corresponding to a single code summary 416, but can be used to generate a plurality of code summary quality scores corresponding to a plurality of code summaries.

As illustrated in FIG. 4, the code summary evaluation service 120 includes a code generation LLM 440. The code summary 416 is provided to the code summary evaluation service 120 (such as to the code generation LLM 440), with a prompt 417 to generate a code block from the code summary 416. Note that the original code block 404 is not provided to the code generation LLM 440. In an example, no other information about the code block 404 is provided to the code generation LLM 440, other than the code summary 416, along with an appropriate prompt 417 to generate a code block from the code summary 416.

In an example, the code generation LLM 440 is a fixed LLM, such as having fixed inference parameters. For example, if the code generation LLM 440 is reconstructing multiple code blocks from corresponding multiple code summaries (e.g., as will be the case for any of FIGS. 1-3), the same set of values of the inference parameters of the code generation LLM 440 may be used for such code reconstruction for the multiple code blocks. This ensures that the code reconstruction process is fair, e.g., when generating a plurality of code summary quality scores. Examples of inference parameters for an LLM have been described above.

The code generation LLM 440 generates a code block 444, based on the code summary 416 and the prompt 417. In an example, the code block 444 is a reconstructed version of the code block 404, and hence, is also referred to as a reconstructed code block 444. For example, in an ideal world where the code summary 416 is assumed to be a perfect summary of the code block 404 and where the code generation LLM 440 is assumed to perfectly generate the code block 444 from the code summary 416, the original code block 404 and the reconstructed code block 444 should ideally be fully functionally correlated (such as functionally match) and may be a functional replica of each other. However, in a realistic scenario, there may be errors or mismatch between the original code block 404 and the reconstructed code block 444, e.g., due to imperfections in the code summary 416 (e.g., the code summary 416 not being an ideal or perfect summary of the code block 404).

In an example, the code summary evaluation service 120 includes a code correlation service 448, which correlates the original code block 404 and the reconstructed code block 444, and generates the code summary quality score 424. For example, the more correlated the original code block 404 is to the reconstructed code block 444, the higher the code summary quality score 424. In an idea case where the original code block 404 and the reconstructed code block 444 are fully correlated (e.g., matches fully), the code summary quality score 424 may be the highest (such as indicating 100% match). Further details of the code correlation service 448 is described below.

Thus, the code summary quality score 424 is indicative of how well the code summarization LLM 112 generated the code summary 416 from the original code block 404, such that the original code block 404 can be reconstructed from the original code block 404. In other words, the code summary quality score 424 is indicative of a quality of summarization of the code block 404 by the code summary evaluation service 120, while generating the code summary 416.

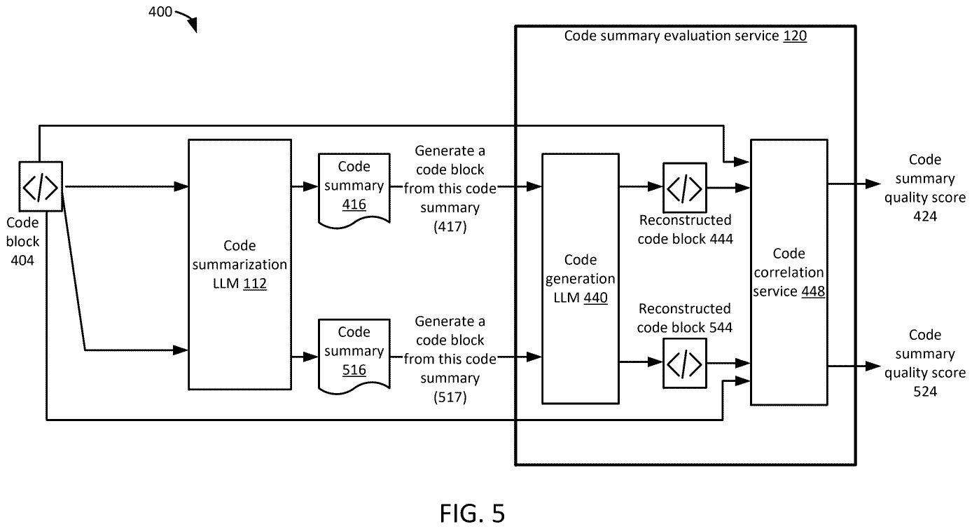

FIG. 5 illustrates the code summary evaluation service 120 of FIG. 4 and may be usable with any of the systems 100, 200, or 300 of FIGS. 1-3, wherein the code summary evaluation service 120 in FIG. 5 generates two different code summary quality scores 424, 524 for two different code summaries 416, 516 generated by a code summarization LLM 112. For example, the code summarization LLM 112 generates two different code summaries 416 and 516 corresponding to the code block 404 (e.g., as discussed with respect to FIGS. 1 and 2). The code summaries 416 and 516 are provided to the code generation LLM 440, along with prompts 417, 517, respectively, to generate code blocks from the respective code summaries. The code generation LLM 440 generates a reconstructed code block 444 from the code summary 416, and generates another reconstructed code block 544 from the code summary 516.

The code correlation service 448 correlates the original code block 404 and the reconstructed code block 444, to generate a corresponding code summary quality score 424 indicative of a quality of the code summary 416. Similarly, the code correlation service 448 correlates the original code block 404 and the reconstructed code block 544, to generate a corresponding code summary quality score 524 indicative of a quality of the code summary 516.

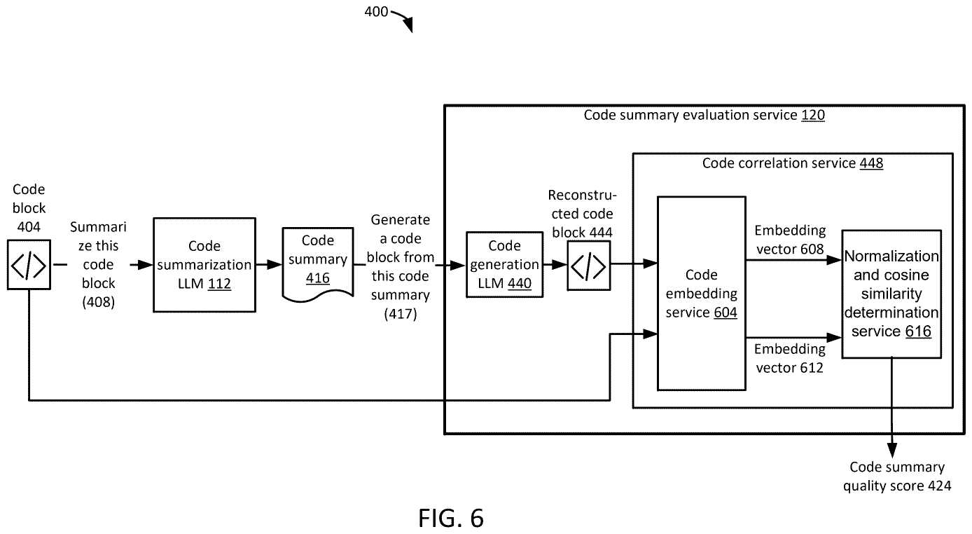

FIG. 6 illustrates a code correlation service 448 of FIGS. 4 and 5 in detail. FIG. 6 illustrates the use case of FIG. 4, where the code correlation service 448 receives the reconstructed code block 444 and the original code block 404, and correlates the reconstructed code block 444 and the original code block 404.

In an example, the code correlation service 448 comprises a code embedding service 604 that receives the reconstructed code block 444 and the original code block 404. The code embedding service 604 performs a code embedding of the reconstructed code block 444, to generate an embedding vector 608. Similarly, code embedding service 604 performs a code embedding of the original code block 404, to generate an embedding vector 612.

Code embedding performed by the code embedding service 604 converts a code block (such as the code blocks 444, 404) into a numerical representation, also referred to as embedding vector. Each of the embedding vectors 608, 612 captures the semantics, structure, and functionality of the corresponding code block. For example, the embedding vector 608 captures the semantics, structure, and functionality of the reconstructed code block 444. Similarly, the embedding vector 612 captures the semantics, structure, and functionality of the original code block 404.

In an example, the embedding vectors 608, 612 may have a size of [1, dₘₐₓ], where dₘₐₓ denotes a maximum dimensionality of the embedding outputs of the code embedding service 604.

As an oversimplified example, assume that the code block 404 has the following routine:

def add_numbers(a, b):
return a+b

This is a simple Python code that defines a function add_numbers, which is a sum of two numbers a and b, and which may be specified in the code summary 416. The function can be expressed in other manners as well. Assume that the code generation LLM 440 receives the code summary 416, and outputs the following reconstructed code 444:

def add_numbers(a, b):
result =a+b
return result

In this example, while the code blocks 404 and 444 look slightly different syntactically, they perform the same operation. For this example, the code embedding service 604 represents these two code blocks 404 and 444 with similar embedding vectors, capturing their functional similarity, in spite of the textual differences between the two code blocks 404 and 444.

In an example, the code correlation service 448 further comprises a normalization and cosine similarity determination service 616. The normalization and cosine similarity determination service 616 initially normalizes the embedding vectors 608 and 618, e.g., to ensure the embedding vectors 608 and 618 are both on the same scale, such that a comparison made between the two is valid. If the code embedding service 604 outputs normalized embedding vectors 608 and 612, then the normalization process performed by the normalization and cosine similarity determination service 616 may optionally be skipped, in an example.

After the embedding vectors 608 and 612 are normalized, a similarity or correlation between the embedding vectors 608 and 612 is determined by the normalization and cosine similarity determination service 616. In the example of FIG. 6, a cosine similarity metric is determined by the normalization and cosine similarity determination service 616. The cosine similarity metric is an indication of a closeness of the two embedding vectors 608 and 612 to each other in the vector space. In an example, cosine similarity metric is bounded between −1 and 1.

For example, the cosine similarity metric being closer to 1 implies that the two embedding vectors 608 and 612 are closer to one another, and the cosine similarity metric being closer to 0 implies that the two embedding vectors 608 and 612 are further from one another. Accordingly, in an example, the cosine similarity metric being closer to 1 implies that the reconstructed code block 444 and the original code block 404 are relatively more similar to one another, and the cosine similarity metric being closer to 0 implies that the reconstructed code block 444 and the original code block 404 are relatively dissimilar from one another.

In an example, the code correlation service 448 generates the code summary quality score 424 for the code summary 416, based on the cosine similarity metric. For example, based on the cosine similarity metric, a judgement may be taken on a quality of the code summary 416 generated by the code summarization LLM 112. In an example, the cosine similarity metric may be output as the code summary quality score 424. In another example, a trained ML model may be used to generate the code summary quality score 424, based on the cosine similarity metric.

Note that in FIG. 6, the normalization and cosine similarity determination service 616 receives the two embedding vectors 608 and 612, and generates the code summary quality score 424, based on a cosine similarity metric. However, instead of using a cosine similarity function, another appropriate technique may be used to generate the code summary quality score 424 from the two embedding vectors 608 and 612. Merely as an example, an ML model may be trained to receive two embedding vectors (e.g., one corresponding to an original code block and another corresponding to a reconstructed code block), and generate a code summary quality score based on correlating the two embedding vectors.

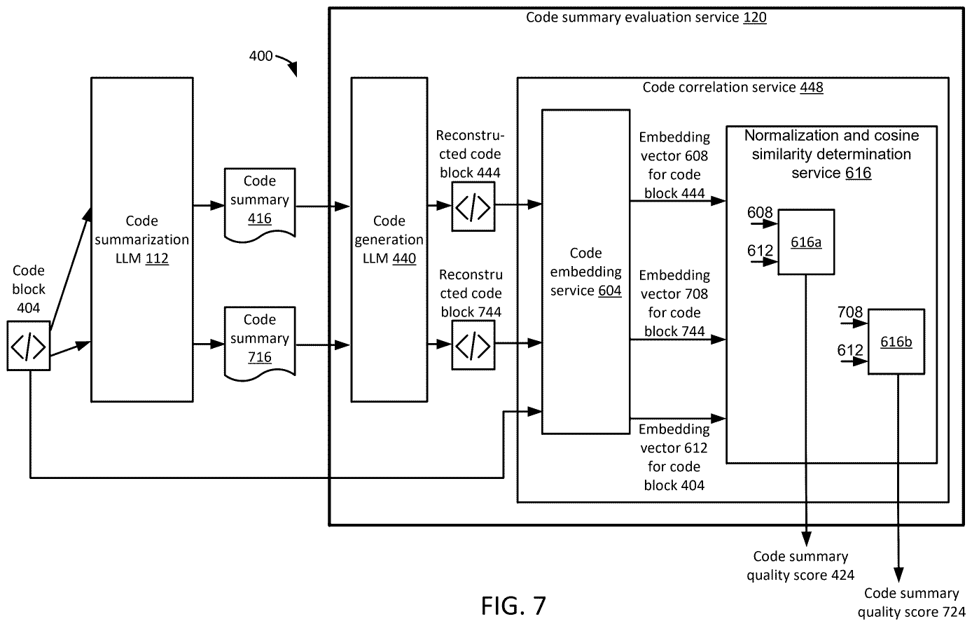

FIG. 7 illustrates operation of a code summary evaluation service 120 that generates two different code summary quality scores 424, 724 for two different code summaries 416, 716 generated by a code summarization LLM 112. For example, the code summarization LLM 112 generates two different code summaries 416 and 716 corresponding to the code block 404 (e.g., as discussed with respect to FIGS. 1 and 2). The code summaries 416 and 716 are provided to the code generation LLM 440, to generate code blocks from the respective code summaries. The code generation LLM 440 generates a reconstructed code block 444 from the code summary 416, and generates another reconstructed code block 744 from the code summary 516.

The code embedding service 604 of the code summary evaluation service 120 generates (i) the embedding vector 608 for the reconstructed code block 444, (ii) the embedding vector 612 for the original code block 404, and (iii) an embedding vector 708 for the reconstructed code block 744.

The normalization and cosine similarity determination service 616 performs two sets of operations, symbolically illustrated by blocks 616a and 616b in FIG. 7. During a first set of operation 616a, the normalization and cosine similarity determination service 616 (i) normalizes the embedding vectors 608 and 612, (ii) determines a cosine similarity metric based on the embedding vectors 608 and 612, and (iii) assigns the code summary quality score 424 to the code summary 416, based on the determined cosine similarity metric.

During a second set of operation 616b, the normalization and cosine similarity determination service 616 (i) normalizes the embedding vectors 708 and 612, (ii) determines a cosine similarity metric based on the embedding vectors 708 and 612, and (iii) assigns a code summary quality score 724 to the code summary 716, based on the determined cosine similarity metric.

Thus, as illustrated in FIG. 7, the code summary evaluation service 120 can evaluate a plurality of code summary quality scores, based on a corresponding plurality of code summaries. In one example, such a plurality of code summaries may be generated by a single code summarization LLM 112. In another example, a first code summarization LLM may generate a first subset of the plurality of code summaries and a second code summarization LLM may generate a second subset of the plurality of code summaries, e.g., as illustrated in FIG. 3.

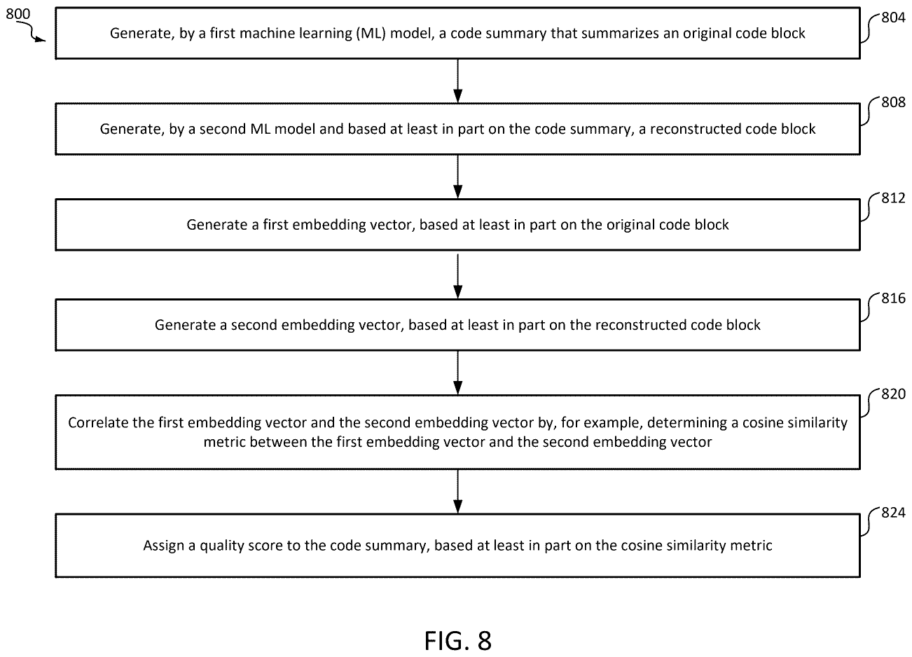

FIG. 8 illustrates a flow chart depicting a method 800 for evaluation of a code summary generated by a code summarization LLM. The method may be performed by any of the systems described above with respect to FIGS. 1-7.

At 804, a first ML model generates a code summary that summarizes an original code block. For example, as illustrated in FIG. 6, the code summarization LLM 112 generates a code summary 416.

At 808, a second ML model generates, based at least in part on the code summary, a reconstructed code block. For example, as illustrated in FIG. 6, the code generation LLM 440 generates a reconstructed code block 444, based at least in part on the code summary 416.

At 812, a first embedding vector is generated, based at least in part on the original code block. For example, as illustrated in FIG. 6, the code embedding service 604 generates the embedding vector 612, based at least in part on the original code block 404.

At 816, a second embedding vector is generated, based at least in part on the reconstructed code block. For example, as illustrated in FIG. 6, the code embedding service 604 generates the embedding vector 608, based at least in part on the reconstructed code block 444.

At 820, the first embedding vector and the second embedding vector are correlated, for example, by determining a cosine similarity metric between the first embedding vector and the second embedding vector. For example, as illustrated in FIG. 6, the normalization and cosine similarity determination service 616 determines a cosine similarity metric between the embedding vectors 608 and 612.

At 824, a quality score is assigned to the code summary, based at least in part on the cosine similarity metric, as also described above with respect to FIG. 6.

### Computer System Architecture

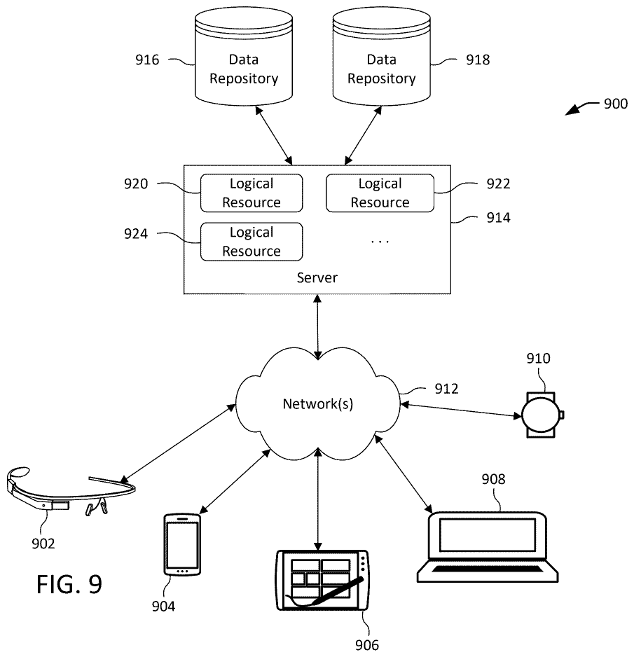

FIG. 9 depicts a simplified diagram of a distributed system 900 for implementing an embodiment. In the illustrated embodiment, distributed system 900 includes one or more client computing devices 902, 904, 906, 908, and/or 910 coupled to a server 914 via one or more communication networks 912. Clients computing devices 902, 904, 906, 908, and/or 910 may be configured to execute one or more applications.

In various aspects, server 914 may be adapted to run one or more services or software applications that enable techniques for evaluating code summaries generated from code blocks and by ML models, such as LLMs.

In certain aspects, server 914 may also provide other services or software applications that can include non-virtual and virtual environments. In some aspects, these services may be offered as web-based or cloud services, such as under a Software as a Service (SaaS) model to the users of client computing devices 902, 904, 906, 908, and/or 910. Users operating client computing devices 902, 904, 906, 908, and/or 910 may in turn utilize one or more client applications to interact with server 914 to utilize the services provided by these components.

In the configuration depicted in FIG. 9, server 914 may include one or more components 920, 922 and 924 that implement the functions performed by server 914. These components may include software components that may be executed by one or more processors, hardware components, or combinations thereof. It should be appreciated that various different system configurations are possible, which may be different from distributed system 900. The embodiment shown in FIG. 9 is thus one example of a distributed system for implementing an embodiment system and is not intended to be limiting.

Users may use client computing devices 902, 904, 906, 908, and/or 910 for evaluating code summaries generated from code blocks and by ML models, such as LLMs in accordance with the teachings of this disclosure. A client device may provide an interface that enables a user of the client device to interact with the client device. The client device may also output information to the user via this interface. Although FIG. 9 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 912 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 912 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 914 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 914 can include one or more virtual machines running virtual operating systems, or other computing architectures involving virtualization such as one or more flexible pools of logical storage devices that can be virtualized to maintain virtual storage devices for the server. In various aspects, server 914 may be adapted to run one or more services or software applications that provide the functionality described in the foregoing disclosure.

The computing systems in server 914 may run one or more operating systems including any of those discussed above, as well as any commercially available server operating system. Server 914 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 914 may include one or more applications to analyze and consolidate data feeds and/or event updates received from users of client computing devices 902, 904, 906, 908, and/or 910. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 914 may also include one or more applications to display the data feeds and/or real-time events via one or more display devices of client computing devices 902, 904, 906, 908, and/or 910.

Distributed system 900 may also include one or more data repositories 916, 918. These data repositories may be used to store data and other information in certain aspects. For example, one or more of the data repositories 916, 918 may be used to store information for techniques for evaluating code summaries generated from code blocks and by ML models, such as LLMs. Data repositories 916, 918 may reside in a variety of locations. For example, a data repository used by server 914 may be local to server 914 or may be remote from server 914 and in communication with server 914 via a network-based or dedicated connection. Data repositories 916, 918 may be of different types. In certain aspects, a data repository used by server 914 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 916, 918 may also be used by applications to store application data. The data repositories used by applications may be of different types such as, for example, a key-value store repository, an object store repository, or a general storage repository supported by a file system.

In one embodiment, server 914 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

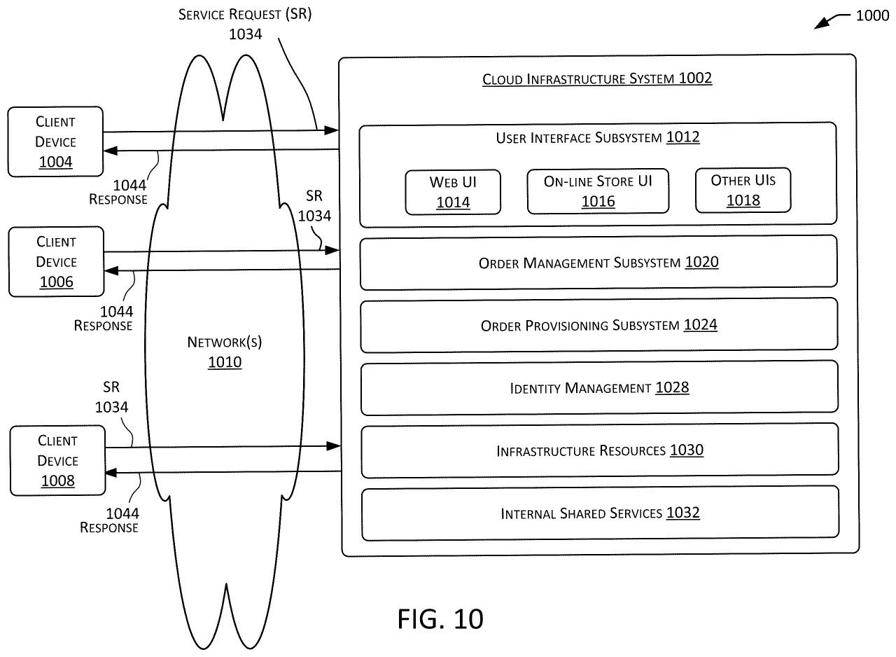

FIG. 10 is a simplified block diagram of a cloud-based system environment 1000 in which techniques for evaluating code summaries generated from code blocks and by ML models, such as LLMs, may be implemented, in accordance with certain aspects. In the embodiment depicted in FIG. 10, cloud infrastructure system 1002 may provide one or more cloud services that may be requested by users using one or more client computing devices 1004, 1006, and 1008. Cloud infrastructure system 1002 may comprise one or more computers and/or servers that may include those described above for server 914. The computers in cloud infrastructure system 1002 may be organized as general purpose computers, specialized server computers, server farms, server clusters, or any other appropriate arrangement and/or combination.

Network(s) 1010 may facilitate communication and exchange of data between clients 1004, 1006, and 1008 and cloud infrastructure system 1002. Network(s) 1010 may include one or more networks. The networks may be of the same or different types. Network(s) 1010 may support one or more communication protocols, including wired and/or wireless protocols, for facilitating the communications.

The embodiment depicted in FIG. 10 is only one example of a cloud infrastructure system and is not intended to be limiting. It should be appreciated that, in some other aspects, cloud infrastructure system 1002 may have more or fewer components than those depicted in FIG. 10, may combine two or more components, or may have a different configuration or arrangement of components. For example, although FIG. 10 depicts three client computing devices, any number of client computing devices may be supported in alternative aspects.

The term cloud service is generally used to refer to a service that is made available to users on demand and via a communication network such as the Internet by systems (e.g., cloud infrastructure system 1002) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1010 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1002 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1002 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1002. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1002. Cloud infrastructure system 1002 then performs processing to provide the services requested in the tenant's subscription order. Cloud infrastructure system 1002 may be configured to provide one or even multiple cloud services.

Cloud infrastructure system 1002 may provide the cloud services via different deployment models. In a public cloud model, cloud infrastructure system 1002 may be owned by a third party cloud services provider and the cloud services are offered to any general public tenant, where the tenant can be an individual or an enterprise. In certain other aspects, under a private cloud model, cloud infrastructure system 1002 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1002 and the services provided may be shared by several organizations in a related community. Various other models such as hybrids of the above mentioned models may also be used.

Client computing devices 1004, 1006, and 1008 may be of different types (such as devices 902, 904, 906, and 908 depicted in FIG. 9) and may be capable of operating one or more client applications. A user may use a client device to interact with cloud infrastructure system 1002, such as to request a service provided by cloud infrastructure system 1002.

In some aspects, the processing performed by cloud infrastructure system 1002 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1002 for determining the intent of an utterance. The data used for this analysis may include structured data (e.g., data stored in a database or structured according to a structured model) and/or unstructured data (e.g., data blobs (binary large objects)).

As depicted in the embodiment in FIG. 10, cloud infrastructure system 1002 may include infrastructure resources 1030 that are utilized for facilitating the provision of various cloud services offered by cloud infrastructure system 1002. Infrastructure resources 1030 may include, for example, processing resources, storage or memory resources, networking resources, and the like.

In certain aspects, to facilitate efficient provisioning of these resources for supporting the various cloud services provided by cloud infrastructure system 1002 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1002 may itself internally use services 1032 that are shared by different components of cloud infrastructure system 1002 and which facilitate the provisioning of services by cloud infrastructure system 1002. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1002 may comprise multiple subsystems. These subsystems may be implemented in software, or hardware, or combinations thereof. As depicted in FIG. 10, the subsystems may include a user interface subsystem 1012 that enables users of cloud infrastructure system 1002 to interact with cloud infrastructure system 1002. User interface subsystem 1012 may include various different interfaces such as a web interface 1014, an online store interface 1016 where cloud services provided by cloud infrastructure system 1002 are advertised and are purchasable by a consumer, and other interfaces 1018. For example, a tenant may, using a client device, request (service request 1034) one or more services provided by cloud infrastructure system 1002 using one or more of interfaces 1014, 1016, and 1018. For example, a tenant may access the online store, browse cloud services offered by cloud infrastructure system 1002, and place a subscription order for one or more services offered by cloud infrastructure system 1002 that the tenant wishes to subscribe to. The service request may include information identifying the tenant and one or more services that the tenant desires to subscribe to. For example, a tenant may place a subscription order for a chatbot related service offered by cloud infrastructure system 1002. As part of the order, the client may provide information identifying the input (e.g. utterances).

In certain aspects, such as the embodiment depicted in FIG. 10, cloud infrastructure system 1002 may comprise a service management subsystem (OMS) 1020 that is configured to process the new order. As part of this processing, OMS 1020 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1020 may then invoke the service provisioning subsystem (OPS) 1024 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1024 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1002 may send a response or notification 1044 to the requesting tenant to indicate when the requested service is now ready for use. In some instances, information (e.g., a link) may be sent to the tenant that enables the tenant to start using and availing the benefits of the requested services.

Cloud infrastructure system 1002 may provide services to multiple tenants. For each tenant, cloud infrastructure system 1002 is responsible for managing information related to one or more subscription orders received from the tenant, maintaining tenant data related to the orders, and providing the requested services to the tenant or clients of the tenant. Cloud infrastructure system 1002 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1002 may provide services to multiple tenants in parallel. Cloud infrastructure system 1002 may store information for these tenants, including possibly proprietary information. In certain aspects, cloud infrastructure system 1002 comprises an identity management subsystem (IMS) 1028 that is configured to manage tenant's information and provide the separation of the managed information such that information related to one tenant is not accessible by another tenant. IMS 1028 may be configured to provide various security-related services such as identity services, such as information access management, authentication and authorization services, services for managing tenant identities and roles and related capabilities, and the like.

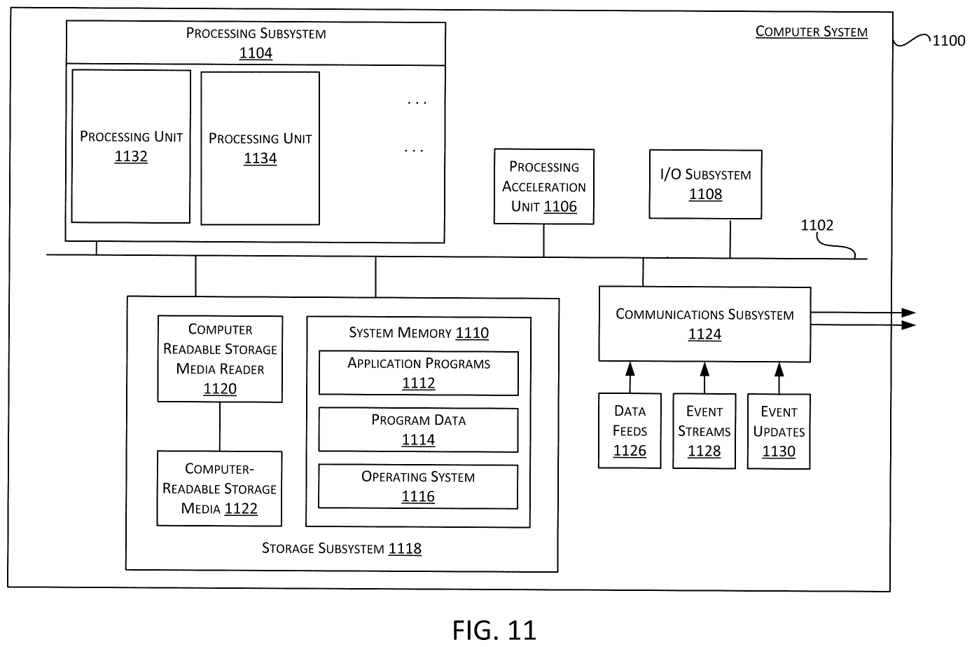

FIG. 11 illustrates an exemplary computer system 1100 that may be used to implement certain aspects. As shown in FIG. 11, computer system 1100 includes various subsystems including a processing subsystem 1104 that communicates with a number of other subsystems via a bus subsystem 1102. These other subsystems may include a processing acceleration unit 1106, an I/O subsystem 1108, a storage subsystem 1118, and a communications subsystem 1124. Storage subsystem 1118 may include non-transitory and/or transitory computer-readable storage media including storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative aspects of the bus subsystem may utilize multiple buses. Bus subsystem 1102 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1104 controls the operation of computer system 1100 and may comprise one or more processors, application specific integrated circuits (ASICs), or field programmable gate arrays (FPGAs). The processors may be single core or multicore processors. The processing resources of computer system 1100 can be organized into one or more processing units 1132, 1134, etc. A processing unit may include one or more processors, one or more cores from the same or different processors, a combination of cores and processors, or other combinations of cores and processors. In some aspects, processing subsystem 1104 can include one or more special purpose co-processors such as graphics processors, digital signal processors (DSPs), or the like. In some aspects, some or all of the processing units of processing subsystem 1104 can be implemented using customized circuits, such as application specific integrated circuits (ASICs), or field programmable gate arrays (FPGAs).

In some aspects, the processing units in processing subsystem 1104 can execute instructions stored in system memory 1110 or on computer readable storage media 1122. In various aspects, the processing units can execute a variety of programs or code instructions and can maintain multiple concurrently executing programs or processes. At any given time, some or all of the program code to be executed can be resident in system memory 1110 and/or on computer-readable storage media 1122 including potentially on one or more storage devices. Through suitable programming, processing subsystem 1104 can provide various functionalities described above. In instances where computer system 1100 is executing one or more virtual machines, one or more processing units may be allocated to each virtual machine.

In certain aspects, a processing acceleration unit 1106 may optionally be provided for performing customized processing or for off-loading some of the processing performed by processing subsystem 1104 so as to accelerate the overall processing performed by computer system 1100.

I/O subsystem 1108 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1118 provides a repository or data store for storing information and data that is used by computer system 1100. Storage subsystem 1118 provides a tangible non-transitory computer-readable storage medium for storing the basic programming and data constructs that provide the functionality of some aspects. Storage subsystem 1118 may store software (e.g., programs, code modules, instructions) that when executed by processing subsystem 1104 provides the functionality described above. The software may be executed by one or more processing units of processing subsystem 1104. Storage subsystem 1118 may also provide a repository for storing data used in accordance with the teachings of this disclosure.

Storage subsystem 1118 may include one or more non-transitory memory devices, including volatile and non-volatile memory devices. As shown in FIG. 11, storage subsystem 1118 includes a system memory 1110 and a computer-readable storage media 1122. System memory 1110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1104. In some implementations, system memory 1110 may include multiple different types of memory, such as static random access memory (SRAM), dynamic random access memory (DRAM), and the like.

By way of example, and not limitation, as depicted in FIG. 11, system memory 1110 may load application programs 1112 that are being executed, which may include various applications such as Web browsers, mid-tier applications, relational database management systems (RDBMS), etc., program data 1114, and an operating system 1116. By way of example, operating system 1116 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1122 may store programming and data constructs that provide the functionality of some aspects. Computer-readable media 1122 may provide storage of computer-readable instructions, data structures, program modules, and other data for computer system 1100. Software (programs, code modules, instructions) that, when executed by processing subsystem 1104 provides the functionality described above, may be stored in storage subsystem 1118. By way of example, computer-readable storage media 1122 may include non-volatile memory such as a hard disk drive, a magnetic disk drive, an optical disk drive such as a CD ROM, digital video disc (DVD), a Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1118 may also include a computer-readable storage media reader 1120 that can further be connected to computer-readable storage media 1122. Reader 1120 may receive and be configured to read data from a memory device such as a disk, a flash drive, etc.

In certain aspects, computer system 1100 may support virtualization technologies, including but not limited to virtualization of processing and memory resources. For example, computer system 1100 may provide support for executing one or more virtual machines. In certain aspects, computer system 1100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to establish a communication channel to one or more client devices via the Internet for receiving and sending information from and to the client devices. For example, the communications subsystem may be used to transmit a response to a user regarding the inquiry for a chatbot.

Communications subsystem 1124 may support both wired and/or wireless communication protocols. For example, in certain aspects, communications subsystem 1124 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1124 can provide wired network connectivity (e.g., Ethernet) in addition to or instead of a wireless interface.

Communications subsystem 1124 can receive and transmit data in various forms. For example, in some aspects, in addition to other forms, communications subsystem 1124 may receive input communications in the form of structured and/or unstructured data feeds 1126, event streams 1128, event updates 1130, and the like. For example, communications subsystem 1124 may be configured to receive (or send) data feeds 1126 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1124 may be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to communicate data from computer system 1100 to other computer systems or networks. The data may be communicated in various different forms such as structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
generating, by a first machine learning (ML) model, a code summary that summarizes an original code block;
generating, by a second ML model and based at least in part on the code summary, a reconstructed code block;
generating a first embedding vector, based at least in part on the original code block;
generating a second embedding vector, based at least in part on the reconstructed code block;
correlating the first embedding vector and the second embedding vector; and
based at least in part on correlating the first embedding vector and the second embedding vector, assigning a quality score to the code summary.

2. The non-transitory computer-readable medium of claim 1, wherein correlating the first embedding vector and the second embedding vector comprises:
correlating the first embedding vector and the second embedding vector by (i) determining a cosine similarity between the first embedding vector and the second embedding vector, and (ii) generating a cosine similarity metric, based at least in part on the cosine similarity between the first embedding vector and the second embedding vector.

3. The non-transitory computer-readable medium of claim 2, wherein assigning the quality score to the code summary comprises:
assigning the quality score to the code summary, based at least in part on the cosine similarity metric.

4. The non-transitory computer-readable medium of claim 2, wherein assigning the quality score to the code summary comprises:
assigning the cosine similarity metric as the quality score to the code summary.

5. The non-transitory computer-readable medium of claim 1, wherein the code summary is a first code summary, the reconstructed code block is a first reconstructed code block, the quality score is a first quality score, and wherein the operations further include:
generating, by the first ML model, a second code summary that summarizes the original code block;
generating, by the second ML model and based at least in part on the second code summary, a second reconstructed code block;
generating a third embedding vector, based at least in part on the second reconstructed code block;
correlating the first embedding vector and the third embedding vector; and
based at least in part on correlating the first embedding vector and the third embedding vector, assigning a second quality score to the second code summary.

6. The non-transitory computer-readable medium of claim 5, wherein the operations further include:
determining that the first quality score is higher than the second quality score; and
based at least in part on determining that the first quality score is higher than the second quality score, selecting the first code summary over the second code summary as a relatively better summary of the original code block.

7. The non-transitory computer-readable medium of claim 5, wherein:
generating, by the first ML model, the first code summary comprises generating the first code summary based at least in part on a first prompt provided to the first ML model;
generating, by the first ML model, the second code summary comprises generating the second code summary based at least in part on a second prompt provided to the first ML model, wherein the first prompt and the second prompt are different; and
the operations further include:
refraining from varying a plurality of inference parameters of the first ML model while the first code summary and the second code summary are generated, such that differences between the first code summary and the second code summary are due to differences between the first prompt and the second prompt.

8. The non-transitory computer-readable medium of claim 5, wherein:
generating, by the first ML model, the first code summary and the second code summary comprises generating the first code summary and the second code summary based at least in part on a same prompt provided to the first ML model; and
the operations further include:
configuring (i) a first set of values for a plurality of inference parameters of the first ML model while the first code summary is being generated and (ii) a second set of values for the plurality of inference parameters of the first ML model while the second code summary is being generated, such that differences between the first code summary and the second code summary are due to differences between the first set of values and the second set of values.

9. The non-transitory computer-readable medium of claim 1, wherein the code summary is a first code summary, the reconstructed code block is a first reconstructed code block, the quality score is a first quality score, and wherein the operations further include:
generating, by a third ML model, a second code summary that summarizes the original code block;
generating, by the second ML model and based at least in part on the second code summary, a second reconstructed code block;
generating a third embedding vector, based at least in part on the second reconstructed code block;
correlating the first embedding vector and the third embedding vector; and
based at least in part on correlating the first embedding vector and the third embedding vector, assigning a second quality score to the second code summary.

10. The non-transitory computer-readable medium of claim 9, wherein the operations further include:
evaluating a suitability of the first ML model versus the third ML model for generating code summaries, based at least in part on the first quality score and the second quality score.

11. The non-transitory computer-readable medium of claim 9, wherein the second ML model is a fixed ML model, such that a plurality of inference parameters of the second ML model is fixed during generation of the first reconstructed code block and during generation of the second reconstructed code block.

12. The non-transitory computer-readable medium of claim 1, wherein the first ML model is a first large language model (LLM) and the second ML model is a second LLM.

13. The non-transitory computer-readable medium of claim 1, wherein the quality score is indicative of a quality of the code summary generated by the first ML model.

14. A computer implemented method comprising:
generating, by a first machine learning (ML) model, a code summary that summarizes an original code block;
generating, by a second ML model and based at least in part on the code summary, a reconstructed code block;
correlating the original code block and the reconstructed code block; and
based at least in part on correlating the original code block and the reconstructed code block, assigning a quality score to the code summary.

15. The method of claim 14, wherein correlating the original code block and the reconstructed code block comprises:
generating a first embedding vector, based at least in part on the original code block;
generating a second embedding vector, based at least in part on the reconstructed code block; and
correlating the first embedding vector and the second embedding vector.

16. The method of claim 15, wherein correlating the first embedding vector and the second embedding vector comprises:
determining a cosine similarity between the first embedding vector and the second embedding vector; and
generating a cosine similarity metric, based at least in part on the cosine similarity between the first embedding vector and the second embedding vector,
wherein the quality score is assigned to the code summary, based at least in part on the cosine similarity metric.

17. The method of claim 14, wherein the first ML model is a first large language model (LLM) and the second ML model is a second LLM.

18. A system comprising:
one or more processors; and
one or more non-transitory computer-readable media storing instructions, which, when executed by the system, cause the system to perform a set of actions including:
generating, by a first machine learning (ML) model, a code summary that summarizes an original code block;
generating, by a second ML model and based at least in part on the code summary, a reconstructed code block;
correlating the original code block and the reconstructed code block; and
based at least in part on correlating the original code block and the reconstructed code block, assigning a quality score to the code summary.

19. The system of claim 18, wherein correlating the original code block and the reconstructed code block comprises:
generating a first embedding vector, based at least in part on the original code block;
generating a second embedding vector, based at least in part on the reconstructed code block; and
correlating the first embedding vector and the second embedding vector.

20. The system of claim 18, wherein the first ML model is a first large language model (LLM) and the second ML model is a second LLM.
